(19) United States
(12) Patent Application Publication
(10) Pub. No.: US 2009/0094959 A1
(43) Pub. Date: Apr. 16, 2009

(54) PROCEDURE FOR THE PRODUCTION OF JEWELLERY ITEMS, IN PARTICULAR ROPES OR CHAINS, AND ITEMS OBTAINABLE THROUGH SUCH PROCEDURE

(75) Inventor: Silverio Cerato, Mussolente (IT)

Correspondence Address: BROWDY AND NEIMARK, P.L.L.C.;624 NINTH STREET, NW, SUITE 300, WASHINGTON, DC, 20001-5303, US

(73) Assignee: Silmar S.p.A., Romano d'Ezzelino (IT)

(21) Appl. No.: 12/251,678

(22) Filed: Oct. 15, 2008

(30) Foreign Application Priority Data
Oct. 15, 2007 (EP) 07425645.4

(51) Int. Cl. B21L 11/00; F16G 13/00; A44C 5/02

(52) U.S. Cl. 59/1; 59/82; 59/80; 63/4

(57) ABSTRACT

Procedure for making jewellery items such as ropes or chains, which provides for: a step for making a wire at full thickness with an external layer made of precious metal seamed on a support core made of non-precious metal; a coating step of the external layer through winding of adjacent coils of a continuous tape made of precious metal; a diamond-pattern engraving coating step; a step for shaping the wire wound with a diamond-pattern engraved coating, during which the wire is permanently deformed while the coating is deformed less maintaining a stable set of incisions produced by the diamond-pattern engraving operation with an intact shape in a manner to reflect the light in an ideal manner; a step for emptying the core made of non-precious metal through baths in acid solutions.

### FIELD OF APPLICATION

The present invention concerns a procedure for the production of jewellery items, in particular ropes and chains generally, and articles obtainable through such procedure.

Both the procedure and the items subject of the present invention can be advantageously employed in the jewellery industry for the production of items made from precious alloys.

### BACKGROUND ART

Over the years, the industrial sector for the production of jewellery items made from precious metals has registered growth of advanced technology for the production of different shapes of chains and ropes, subsequently used to obtain necklaces, bracelets and other ornamental items.

In particular, items made from diamond-pattern engraved wires at full thickness, which can be easily machined through automatic or semiautomatic machines to make ropes and chains of various shapes and sizes, have been introduced in the market.

More in detail, both the chains and the ropes are generally obtained from a wire at full thickness composed of a support core made of a non-precious metal material (generally iron or aluminium) and by a coating made of a precious metal such as gold, silver or alloys thereof, which is seamed to the core to make a compound wire with the mechanical resistance suitable to bear the machining required for the production of chains and ropes.

Once formed, the ropes and chains are emptied of the internal core made of non-precious metal through baths in acid solutions such as, for example, the known type of bath in hydrochloric acid for the removal of iron cores.

Otherwise, the wire used for the production of ropes and chains can be made in its entire thickness of a precious metal and in this case the finished items do not need to undergo emptying processes.

In any case, once it has reached the desired diameter obtained through shaping processes, the wire used to make the ropes or chains usually has diamond-patterns engraved externally in order to confer the final item produced starting from such wire the brightness required by the market.

For example the ropes, used for the production of necklaces or bracelets, are usually obtained by automatically assembling in succession open links made from pieces of wire. Such ropes are provided with staggered ends to confer the same links, and thus the chains obtained therefrom, a known spiral shape.

Alternatively, the chains are generally obtained from a wire coil suitably cut, shaped and welded by means of an automatic machine. More in detail, the wire is cut into pieces which are shaped into rings and concatenated by passing each single ring through one or more of the other rings. Usually, each ring is twisted slightly, to obtain preferably chains with two parallel faces.

The aforementioned diamond-pattern engraving process is particularly important for the production process given that it is quite influential in terms of determining the brightness of the finished products. Diamond-pattern engraving is performed through surface incisions intended to make engravings with angles designed to reflect the light adding brightness to the finished items.

In practice, when making ropes or chains, it has been observed that if the diamond-pattern engraving process is performed before making the chain links, the brightness due to such process is partially lost during the links (or rings) shaping step, due to the stretching effect of the precious metal layer during the shaping step. As a matter of fact, such stretching leads to the modification of the shape of the incisions, in a manner difficult to control, made during the diamond-pattern engraving process, which reflect the light thus conferring the final items the desired brightness.

Consequently, the diamond-pattern engraving process partially loses its efficiency during the production process and the final items lose part of their brightness which is only partially recovered during the required subsequent surface finishing and polishing steps, such as barrel polishing and thermal treatment.

### PRESENTATION OF THE INVENTION

In this situation, the main aim of the present invention is therefore to provide a procedure for the production of jewellery items, in particular ropes and chains, which confer enhanced brightness to the items.

Another aim of the present invention is to provide a procedure for making jewellery items, which substantially maintain the efficacy of the diamond-pattern engraving process intact in the machining operations subsequent to the same diamond-pattern engraving step.

Further aim of the present invention is to provide an easy and economical procedure for making jewellery items.

Another aim of the present invention is to provide jewellery items, in particular comprising ropes and chains for ornamental purposes, with high brightness.

Advantageously, items obtained through the procedure according to the invention are distinguished by high brightness constant over time.

### BRIEF DESCRIPTION OF THE DRAWINGS

The technical features of the invention, according to the aforementioned aims, are clearly observable from the contents of the claims below and advantages of the same shall be clearer in the detailed description that follow made with reference to the attached drawings, which represent a purely exemplifying and non-limiting embodiment thereof, wherein:

FIG. 1 shows a perspective view of a possible embodiment of the jewellery item according to the present invention composed of a necklace obtained from a rope of hooked links;

FIG. 2 shows an enlarged detail of the item of FIG. 1 related to a single link of the rope;

FIGS. 3A, 3B and 3C show a portion of a seamed wire for making items according to the invention at three different steps of the procedure;

FIGS. 4A, 4B and 4C show a portion of a wire for making items according to the invention at three different steps of the procedure;

FIGS. 5A and 5B show a portion of a third example of a wire for making items according to the invention at two different steps of the procedure;

FIGS. 6A and 6B show two examples of two possible closed links of an ornamental chain according to the invention;

FIG. 7 shows a portion of a chain according to the invention made with the links of FIG. 6A.

### DETAILED DESCRIPTION

With reference to the attached drawings, an example of a jewellery item made according to the procedure subject of the present invention is indicated in its entirety by 1.

The description of the procedure subject of the present invention for the production of a jewellery item such as a rope or a chain for making necklaces, bracelets or other similar items starting from a semi-finished product made of a wire will be set forth below. However, it is to be understood that the same procedure can be employed for the production of even other shapes of items without necessarily departing from the scope of protection of the present invention.

More in detail, the term semi-finished product shall hereinafter mean the base element from which the subsequent coating steps, surface machining, shaping and the other subsequent steps of the procedure shall be made.

Advantageously according to the preferred solution of the present invention described below, such semi-finished product shall be made of a wire with at least one layer made of a precious metal.

Therefore, with reference to the attached figures, the procedure according to the invention initially provides for a manufacturing step of a semi-finished product advantageously composed of a wire at full thickness 2 having at least one external layer 3 composed of a precious metal or of a precious-metal alloy 3.

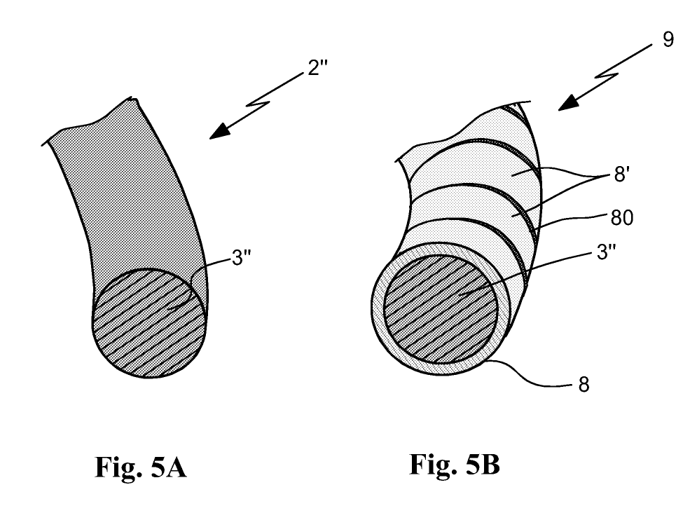

It is to be understood that the wire shall be composed of a filled wire completely made of a precious metal (see FIG. 5), to obtain finished products made of solid metal, or, preferably the wire shall be composed of the external layer 3 alone made of precious metal, the internal core 4 being obtained from a non-precious metal (see FIGS. 2, 3, 4), such as, for example, iron or aluminium, meant to be removed after having shaped the wire according to the desired manner for making items, with tubular links, which are lighter and easy to wear.

For example, the precious metal can be selected from gold, platinum and silver or it can be composed of an alloy of precious metals.

It is important that the wire 2, in order to allow to perform the subsequent machining operations for the production of ornamental items and in particular for making chains or ropes, be filled given that otherwise it would not have enough mechanical resistance to bear machining operations and it would crumple up without allowing to shape the external layer as desired.

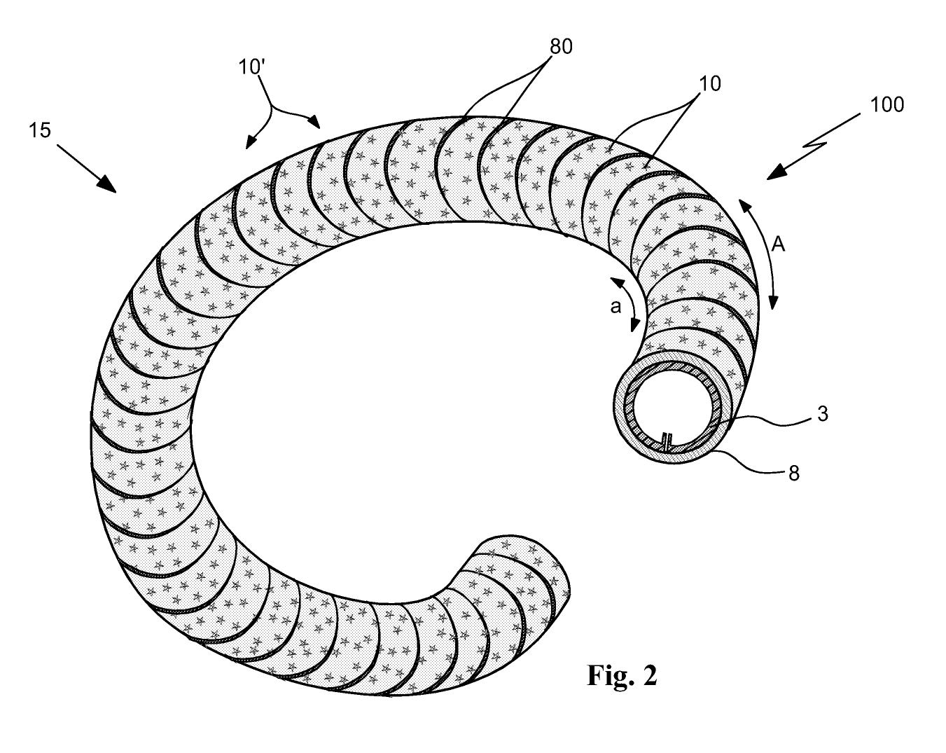

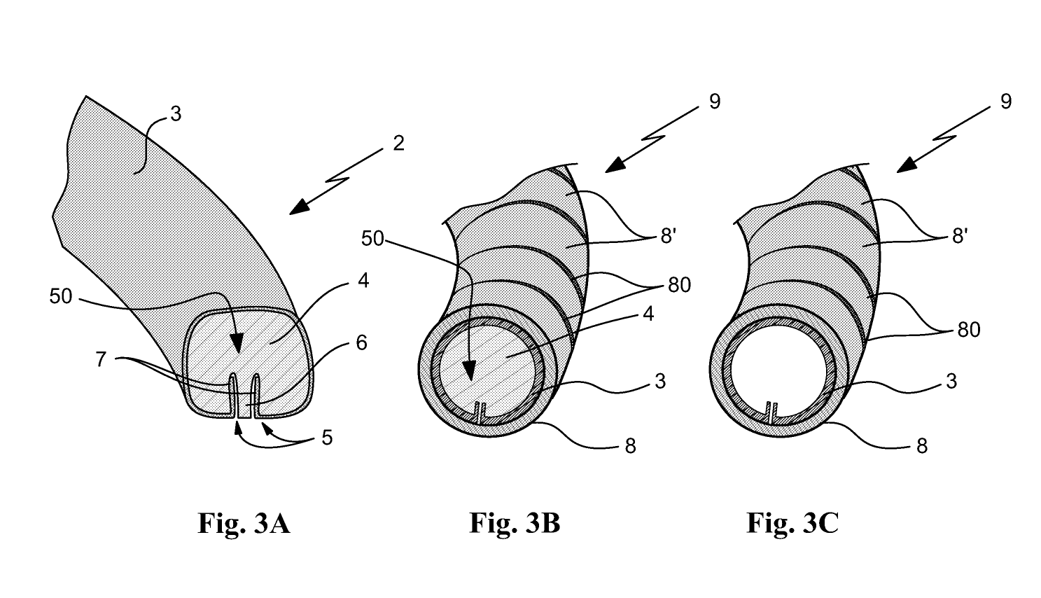

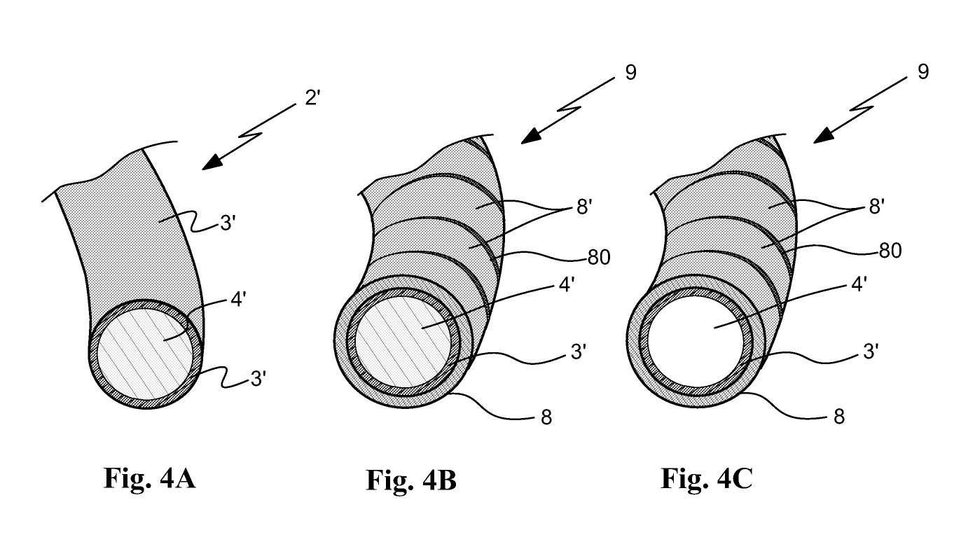

The aforementioned wire 2 at full thickness can be obtained by the seaming 50 of the external layer 3 to the internal core 4 made of a non-precious metal, as illustrated in FIGS. 2, 3A, 3B, 3C or else with the external tubular layer 3′ internally filled with core 4′ made of a non-precious metal, as illustrated in FIGS. 4A, 4B, 4C, otherwise again with a filled wire 2″ made of a precious metal as illustrated in FIGS. 5A and 5B.

With reference to the first preferred embodiment of the present invention, ornamental items composed of tubular links connected in succession can be obtained starting, in an entirely traditional manner, for example from a filled iron wire 4 of 3.90 mm in diameter (see FIG. 3A) on which, through a roller shaping step, two longitudinal parallel incisions 5 separated by a rib 6 are made. In the incisions 5, the strip ends 7 of a tape, for example a golden tape 18.50 mm wide and 0.40 mm thick, are inserted by means of a seaming step; such tape is adapted to make the external layer 3 of the compound wire 2.

Subsequently, the latter undergoes a shaping step until its diameter is reduced for example up to 1.02 mm.

During shaping the strips 7 of the golden tape remain slightly separated due to the interposition of the rib 6 which, though it obviously becomes thin itself, allows to maintain an exit for the iron core for emptying the wire 2 as repeated subsequently.

Therefore, the step for making the filled wire 2 which can be machined, per se already known, can be obtained as indicated above.

With reference to the example embodiment considered previously, the shaping step leads to obtaining a round wire 2 of 1.02 mm in diameter composed of an iron core of approximately 0.90 mm in diameter and by an external golden layer 3 approximately 0.04 mm thick.

At this point, there follows a coating step of the external layer 3 of the wire 2 by winding a plurality of coils 8′ adjacent to each other around it. Such adjacent coils are made of a continuous tape 8 composed of a precious metal or of a precious-metal alloy, thus obtaining a coated wire 9.

The winding of the tape 8 (or coating) around the external layer 3 has a spiral shape with a slight clearance between a coil 8′ and the other adjacent coil.

With reference to the example embodiment considered in this description, for example a tape 8, 0.60 mm wide and 0.16 mm thick, is wound on the external layer 3 of the wire 2.

More generally, the wound tape 8 can have a thickness ranging between 0.04-0.40 mm and width ranging between 0.15-1.50 mm. As explained further ahead the width of the wound tape is preferably proportional to the dimensions of the link to be made.

Hence, the wire thus coated according to the example described above, has an overall thickness of approximately 1.34 mm, which preferably goes through a compacting step of the coating 8 on the wire 2 through hammering, drawing or rolling. This step results in thinning of the wire up to a diameter of 1.25 mm. According to the idea on which the present invention is based, next follows a surface machining step which solely concerns the aforementioned coating 8. Surface machining operations on the semi-finished surface, and in particular of the wire, can be performed by removing the material or without removing the material and they can be meant to enhance the brightness of the semi-finished product i.e. to create special surface aesthetic effects.

The most important surface machining operation through removal of material is the diamond-pattern engraving process which requires making incisions according to predefined patterns in order to create aesthetically appraisable light reflections.

The surface machining operations without removal of material can be for example satinizing, intended to obtain less surface reflection of the light, rolling and hammering intended to obtain special patterns on the surface of the wire, or the semi-finished product in general, adapted to confer enhanced brightness to the latter i.e. obtain an appraisable homogeneous pattern.

Further ahead, reference shall be made to diamond-pattern engraving surface machining operations in that it proved to be surprisingly advantageous for the purpose of the present invention.

The diamond-pattern engraving of the coating of the wound tape 8 is obtained by making a plurality of incisions 10.

In FIG. 2 the incisions are indicated by engravings with extremely enlarged star-shaped drawings for a clear representation of the same.

In the drawings the proportions between various layers were not maintained in order to allow to appreciate all the parts of the wire and of the item.

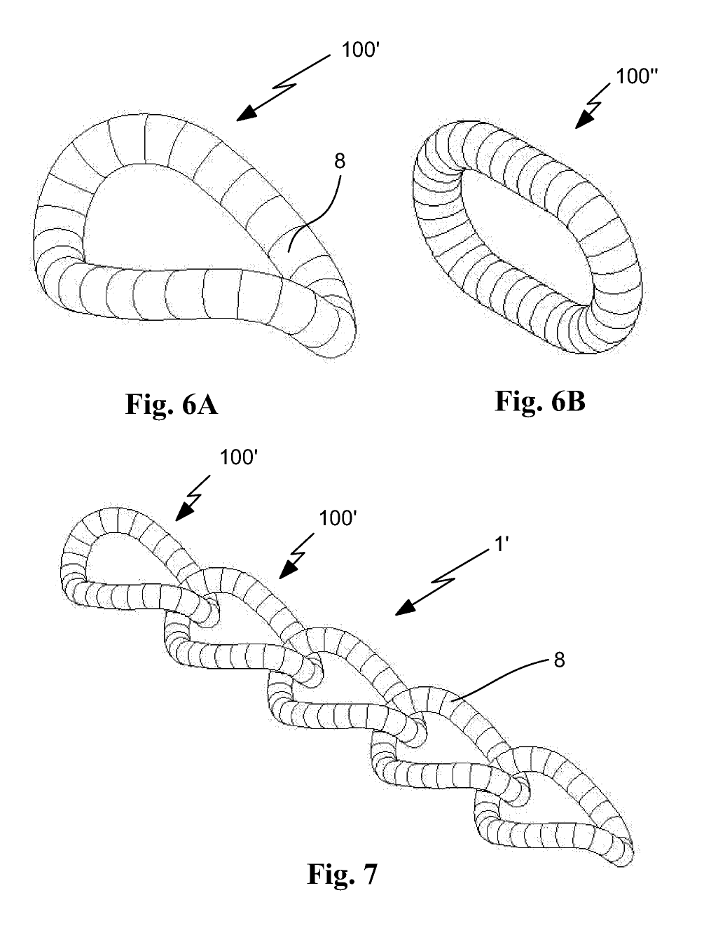

To make the various possible ornamental items such as in particular ropes and chains, the semi-finished product, i.e. in particular the wire, wound with a diamond-pattern engraved coating 9, undergoes a subsequent shaping step, during which pieces of wire are permanently deformed through one or more folds 15 regarding the core 4 and the external layer 3. Such shaping step is particularly meant for shaping links 100, 100′, 100″ for making ropes 1 or chains 1′. FIGS. 2, 6A, 6B show, for exemplifying but not limiting purpose, some possible shapes of links for making ropes and chains. The coating 8 during such shaping operation flows at least partially on the external layer 3 of the wire 2 substantially leaving intact in the shape at least a stable set of incisions 10 made on the coating 8 during the preceding diamond-pattern engraving step. Such stable set of incisions can substantially comprise the totality of the incisions produced by the diamond-pattern engraving operations i.e. only the incisions associated to the areas where the metal was less deformed during the shaping step, such as for example the eternal surface of the fold of the link of FIG. 2 indicated with number 10′.

During shaping the coating 8 shall deform less with respect to the wire 2 given that the clearances present between the coils 8′ wound and adjacent shall allow the coil to open slightly in the part of the folds 15 with a greater radius of curvature (indicated with A in FIG. 2) compensating for the extension of the surface of the wire 2 due to the stretching of the external part of the folds 15 and, on the other hand, they will be compressed in the internal part with a lower radius of curvature (indicated with A in FIG. 2).

In the drawings attached the clearance 80 between the coils 8′ of the coating 8 is indicated with a dark coloured line widened where the coated wire 9 has a greater radius of curvature.

In this manner, the diamond-pattern engraving 10 preserves the patterns and the shapes designed and engraved during the diamond-pattern engraving step conferring to the semi-finished product an ideal reflection of the light and thus high brightness.

The incisions 10 obtained through diamond-pattern engraving operations are made by removal of material and even a slight deformation, due for example to the stretching of the metal, is enough to jeopardise in a considerable manner the visual effect resulting from the diamond-pattern engraving, which as known, is distinguished by its capacity to confer high luminosity to the item.

Though the procedure according to the present invention was advantageously conceived mainly to maintain the diamond-pattern engraving surface machining on the surface of the ornamental item intact without modifying the incisions produced by the diamond-pattern engraving during the subsequent machining operations of the semi-finished products in particular in form of wire as explained above, the procedure also provides for maintaining the surface visual effect of the items obtained through other surface machining operations such as satinizing or rolling.

According to other embodiments, the present invention provides subjecting the coating of the wire to a satinizing or rolling surface machining step instead of the diamond-pattern engraving machining operations and then proceeding to the next step of shaping the wire. The wire thus made and shaped maintains the satinizing or rolling machining operations substantially intact i.e. without the same resulting particularly altered by the shaping step i.e. by the folds produced on the wire. Such circumstance is once again a consequence of the flow of the coating on the wire during the shaping step which allows the coating itself to suffer less deformations with respect to the amount of deformation it would suffer were it to be subject, according to conventional techniques, to a machining step directly on its surface and thus to a shaping step.

Particularly, satinizing and rolling the item obtained by means of the procedure described above have a uniform visual effect even in the zones positioned at the folds. However, in case of diamond-pattern engraving machining operations a surprising high reflection of light on the finished item is observed.

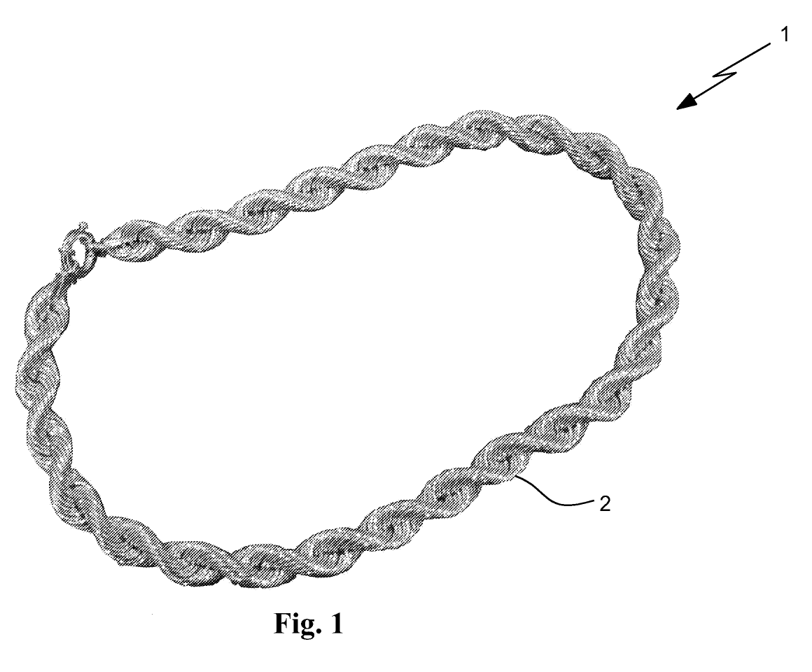

The links 100, 100′, 100″ obtained in this manner suitably shaped are now connected in succession one to the other through concatenation steps of processes of per se conventional automatic machines by means of which the ropes 1 (see FIG. 1) or chains 1′ (see FIG. 7) are made. For example FIG. 1 shows, indicated with 1, a rope obtained through concatenation of links 100 of the type illustrated in FIG. 2 and made as described above.

The production processes of ropes or chains operate according to the procedure subject of the present invention, a semi-finished product and in particular a wire which instead of having diamond-patterns engraved in a conventional manner directly on the surface of the external layer, it is provided with a diamond-pattern engraving 10 applied on the coating tape 8 which covers the external layer 3 of the wire 2.

Once the ropes, the chains with links 100, 100′, 100″ concatenated to each other have been made, or more generally once the ornamental items have been obtained in the desired shape always at full thickness with a diamond-pattern engraved coating 8, it will be necessary, in case the full thickness is made with a core 4 made of non-precious metal, to proceed to remove such core 4. For the purpose the ropes, the chains and more generally the various items produced through the steps described above, are subject to the removal of the core 4, made of non-precious metal, through baths in acid solutions intended to melt the core 4 in the solution.

With reference to the first example embodiment previously proposed, the iron core 4 on which the external golden layer 3 is seamed, is removed by dipping the rope 1 into a bath filled with a hydrochloric acid solution. During permanence in the bath, the iron dissolves into the acid passing through the slot of the wire formed in place of the rib 6.

The duration of the baths in the acid solutions depends on the size of the items i.e. on how easily the core 4 exits from the pipes forming the precious metal-made external layer 3 of the wire.

Once the core removal step is completed, the items are subject to an annealing process to extend the material and remove internal or surface tensions, and then to polishing steps, per se conventional, such as barrel polishing in vibrating drawers filled with small zirconium or steel spheres adapted to abrade the surface of the items removing the asperity and conferring them the brightness required. Therefore, the idea on which the invention is based provides for winding on a semi-finished product, advantageously in form of wire 2 which can be shaped, a continuous tape 8, which after diamond-pattern engraving operations can be machined to make jewels in the desired shapes with a diamond-pattern engraving maintaining its light reflecting qualities substantially intact.

According to a second embodiment, the filled wire indicated with 2′ in FIG. 4 (before coating with the tape 8) can be made with the external layer not seamed to the core but can be of a closed tubular shape 3′ internally filled with the cylindrical core 4′ as illustrated in FIGS. 4A and 4B which represent the wire 2′ before and after the coating while FIG. 4C illustrates the coated wire 9 after the emptying step of the external tubular layer 3′ from the core 4′ made of non-precious metal.

Such semi-finished product 2′ can be made in a per se conventional manner through a machine which shapes the external layer 3′ on the core 4′ starting from a tape made of precious metal which is first U-shaped passing through a first series of pairs of rollers positioned opposite to each other, then it is filled with the core 4′ made of non-precious metal within the U-shaped structure, after which it passes through a second series of pairs of rollers positioned opposite each other intended to close the core 4′ within the shaped external layer 3′ which is lastly closed along the extension of the wire through longitudinal welding of its adjacent strips.

Such method of shaping the wire 2′ is, for example, illustrated in FIGS. 1A-1G and in the related part of description of the U.S. Pat. No. 6,092,358 which are to be considered incorporated for reference to the present patent application.

According to the present invention, when referring to such U.S. Pat. No. 6,092,358, it must also be understood that the internal core must be obtained from a non-precious metal (which is subsequently emptied) and not from silver as described in the U.S. Pat. No. 6,092,358.

Alternatively, the wire 2′ can be obtained by coaxially inserting the rod-shaped core 4′ made of non-precious metal within the external layer 3′ obtained in a tubular shape for example directly through extrusion.

The adherence between the two materials forming the core 4′ and the external layer 3′ is for example obtained through subsequent drawing steps adapted to bring the thickness of the wire and of the external layer to the desired thickness. Such solution is particularly suitable for shaping ropes in which the single links, having the ends open can be easily emptied of the core made of non-precious metal.

Alternatively, the first solution with a seamed wire is particularly suitable for making even links with ring-closed ends particularly suitable for shaping chains given that in this case the core can be easily emptied during the emptying step through the longitudinal slot occupied by the rib 6 of the core 4.

Furthermore, according to a third embodiment the filled wire before coating with the tape, can be made of a precious metal at full thickness as indicated in FIG. 5, where the term “full thickness” shall mean a wire 2″ completely or substantially filled (solid) i.e. thick enough to allow to perform the various shaping machining operations of the links 100, 100′, 100″. Obviously, in case of the wire at full thickness 2″ the emptying step is no longer required.

It is also the object of the present invention to provide for a jewellery item, in particular obtained according to the procedure outlined above whose references shall be therefore maintained.

Analogously to the considerations above regarding the procedure according to the invention, the item is advantageously made up of a rope or a chain for making necklaces, bracelets or other similar products obtained starting from a semi-finished product in form of a wire. However, according to the invention such item can also be of a different shape and obtained starting from a semi-finished product different from a wire and for example made of a thin plate or a tape to be subjected to the subsequent machining steps among which coating, diamond-pattern engraving and shaping described previously.

With reference to the preferred example of the present invention, illustrated in the figures attached, the item comprises a plurality of links concatenated together along a direction Y of extension of the rope or chain.

According to the invention, the folds 15 which determine the shape of the links 100, 100′, 100″ usually open ring-shaped in case they are required to make a rope 1 (se FIG. 2), and of various shapes (see for example FIG. 6A, 6B) in case they are required as rings for making chains 1′, are provided on single pieces of wire formed by an external layer 3 made of precious metal (or of a precious-metal alloy) and by a coating wound in adjacent coils 8′ of a continuous tape 8 made of precious metal (or a precious-metal alloy).

The coating 8 thus formed has a set of stable incisions 10 made through diamond-pattern engravings. Such incisions are not substantially altered, with respect to their shape, by the folds 15 in the that they substantially maintain the efficacy of the diamond-pattern engraving intact.

As a matter of fact, during the shaping step, the coating 8 does not deform contrary to what occurs on the semi-finished product and in particular the wire 2, due to the presence of clearances between the coils 8′ and due to the possibility of the coating 8 to flow partially over the wire 2. In this manner, the incisions 10 produced by the diamond-pattern engraving operation are not seriously deformed after the folds 15 have been made i.e. they are not deformed in a manner such to noticeably modify the reflection effect of the light due to the incisions 10 of the diamond-pattern engravings.

The incisions 10 are more stable on the parts of the folds 15 with a greater radius of curvature (indicated with A in FIG. 2), i.e. on the external edges which usually correspond to the more exposed parts of the links 100, particularly when making ornamental ropes.

The example in FIG. 1 represents a necklace 1 obtained from a link-rope 100 wound in coils having a diameter of 12 mm. The links 100 schematically represented in FIG. 2 are obtained through a single continuous fold 15.

Preferably, the links 100 of the ropes according the invention have a coated wire having a diameter comprised between 0.3 mm and 3 mm with the tape of the coating having a thickness comprised in the range between 0.04-0.40 mm and having a width comprised between 0.15-1.50 mm.

The width of the tape 8 to be wound shall be selected depending on the radius of curvature of the folds 15 being that the smaller the angle of curvature the narrower the tape shall be in order to avoid that when opening the coils 8′ at the external part A of the links 100 form excessively pronounced rungs susceptible to scratching upon contact.

Items such as ropes and chains according to the present invention, in particular obtained according to the procedure described previously, reveal a high brightness due to the fact that the folds 15 do not significantly modify the shape of the incisions 10 produced during the diamond-pattern engraving step, the latter step being performed on the coating 8 which remains largely undeformed during the shaping step.

Therefore, the finding thus conceived attains the aims set forth above.

Obviously, the ornamental items according to the invention can assume, in their embodiments even shapes and configurations different from the ones illustrated above (ropes and chains) without, for this reason, departing from the present scope of protection. For example they can even be composed of rigid bracelets of various shapes commonly referred to, in the jargon of the sector, by the name of “bangles” made starting from semi-finished products made of metallic tapes.

In addition, all the details can be replaced by other technically equivalent elements and the dimensions, shapes and materials used may be of any kind depending on the requirements.

1. Procedure for making jewellery items, in particular ropes or chains, which comprises the following operational steps:
At least a step for making a semi-finished product having at least an external layer composed of a precious metal or of a precious-metal alloy;
At least a coating step of the external layer of said semi-finished product through winding a continuous tape composed of a precious metal or a precious-metal alloy, obtaining a coated semi-finished product;
At least a subsequent surface machining step of the coating of said coated semi-finished product;
At least a subsequent shaping step of said semi-finished product wound with a machined coating, during which said semi-finished product is plastically deformed permanently with one or more folds, at which said coating flows at least partially on said external layer of said semi-finished product.

2. Procedure according to claim 1, characterised in that said surface machining step comprises at least a diamond-pattern engraving step of the coating of said semi-finished product through which a plurality of incisions are made on said coating, at least a stable set of said incisions made on said coating maintaining its shape after said shaping step, substantially intact.

3. Procedure according to claim 1, characterised in that said coating step is performed by winding adjacent coils of the said tape around the external layer of said semi-finished product.

4. Procedure according to claim 1, characterised in that during said shaping step said coating is deformed less with respect to the semi-finished product thanks to the clearance existing between the coils.

5. Procedure according to claim 1, characterised in that said semi-finished product is made at full thickness.

6. Procedure according to claim 5, characterised in that said semi-finished product is made at full thickness with the support core made of a non-precious metal, in particular iron or aluminium.

7. Procedure according to claim 6, characterised in that said semi-finished product at full thickness is a wire.

8. Procedure according to claim 7, characterised in that on said support core made of non-precious metal said external layer is fixed through a seaming step.

9. Procedure according to claim 7, characterised in that said wire is made at full thickness with a support core made of non-precious metal, in particular iron or aluminium, which core is assembled to the said tube-shaped external layer.

10. Procedure according to claim 9, characterised in that said core is inserted within the external layer of said wire while the latter substantially has an open U-shape which is then closed on the core once the core has been inserted.

11. Procedure according to claim 9, characterised in that said core is inserted coaxially within the tube-shaped external layer of said wire.

12. Procedure according to claim 1, characterised in that said wire is subjected to at least one drawing step to bring its diameter and the external layer to the required thicknesses.

13. Procedure according to claim 6 characterised in that it comprises a removal step of said core through baths in acid solutions.

14. Procedure according to claim 1 characterised in that said shaping step is performed on coated and diamond-pattern engraved pieces of wire, and in particular it leads to making links, which are connected to each other through a concatenation step for making ropes or chains.

15. Jewellery item, in particular obtained according to the procedure of claim 1, shaped with one or more folds, characterised in that it comprises at least a semi-finished product having at least an external layer composed of a precious metal or of a precious-metal alloy, and a coating composed of adjacent coils of a continuous tape made of precious metal or precious-metal alloy wound on the external layer of said semi-finished product, said coating bearing surface machining which can be associated to corresponding visual effects, which machining extends uniformly on said folds in a substantially intact manner maintaining said surface light effects.

16. Jewellery item, according to claim 15, wherein at least a said semi-finished product comprises a plurality of links connected to each other along a direction of extension for making a rope or chain, each link being provided with one or more folds and being made of pieces of wire made of precious metal or a precious-metal alloy and of said coating composed of adjacent coils of a continuous tape made of precious metal or precious-metal alloy wound on the external layer of said wire, said coating bearing at least a set of stable incisions of diamond-pattern engravings not substantially altered in the shape by the abovementioned folds.

17. Jewellery item according to claim 16, characterised in that said set of stable incisions is arranged on the external edge of said links.

18. Jewellery item according to claim 16, characterised in that the tape has a thickness comprised in the range between 0.04-0.40 mm and width comprised between 0.15-1.50 mm.

19. Jewellery item according to claim 16, characterised in that it is made up of a rope in which said links have a spiral shape and they are obtained through a coated wire having a diameter comprised between 0.3 mm and 3 mm.
